(19) United States
(12) Patent Application Publication
(10) Pub. No.: US 2025/0309675 A1
(43) Pub. Date: Oct. 2, 2025

(54) THROUGH-WALL SOLAR POWER STATION OUTLET KIT

(71) Applicant: Champion Power Equipment, Inc., Las Vegas, NV (US)

(72) Inventors: Artur Starosciak, Greendale, WI (US); Greg Pauken, Hartland, WI (US)

(21) Appl. No.: 19/089,458

(22) Filed: Mar. 25, 2025

Related U.S. Application Data
(60) Provisional application No. 63/571,348, filed on Mar. 28, 2024.

(51) Int. Cl. H02J 7/35; H02G 3/22; H02J 7/00

(52) U.S. Cl. CPC H02J 7/35; H02G 3/22; H02J 7/0029

(57) ABSTRACT

A through-wall power station outlet kit may include a power inlet box located in an exterior environment and protected with a bubble cover. The power inlet box may include power generation terminals configured for electrical attachment to a power generation device such as an inverter, a generator, and solar panels. On the interior side, a receptacle box may be used with a plurality of power station terminals for electrical connection to a portable power station. A conduit may join the exterior power inlet box to the interior receptacle box such that the conduit is installed within a wall between the exterior and the interior.

### CROSS-REFERENCE TO RELATED APPLICATIONS

The present application is a non-provisional of, and claims priority to, U.S. Provisional Patent Application Ser. No. 63/571,348, filed Mar. 28, 2024, the disclosure of which is incorporated herein by reference in its entirety.

### BACKGROUND OF THE INVENTION

Embodiments of the present invention relate to delivering electrical energy to the interior of a building from one or more solar panels, a generator, or an inverter. More particularly, the present invention is related to an apparatus and method of transferring electrical energy from the solar panels, through an exterior wall, and to the interior of the building for charging portable power supplies.

Portable power supplies, commonly referred to as portable power stations, have become more popular in recent times. Due to battery technology rapidly advancing and economies of scale, they have also become more affordable. As a result, many new applications and needs for portable power stations have developed.

Another market that has seen tremendous growth is solar power generation. Many people desire to transition as much of their power consumption as possible to renewable energy. Combining portable power stations with solar power generation allows this goal to be attained in nearly any location.

One problem with using portable power stations is they need to be recharged. Portable power stations are typically recharged by plugging them into a common house receptacle. Unfortunately, the power supplied by these receptacles is typically not from a renewable source such as solar.

It would therefore be desirable to provide an improved system and method for recharging portable power stations from a solar power generation source, a generator, or an inverter.

It would also be desirable to provide an improved system and method for charging portable power stations indoors with solar panels outside, with options for parallel or series connections to maximize charging efficiency.

### BRIEF STATEMENT OF THE INVENTION

In accordance with one aspect of the invention, a through-wall power station outlet kit may include a power inlet box located in an exterior environment and protected with a bubble cover. The power inlet box may include power generation terminals configured for electrical attachment to a power generation device such as an inverter, a generator, and solar panels. On the interior side, a receptacle box may be used with a plurality of power station terminals for electrical connection to a portable power station. A conduit may join the exterior power inlet box to the interior receptacle box such that the conduit is installed within a wall between the exterior and the interior.

In accordance with another aspect of the invention, the through-wall power station outlet kit may include an exterior power inlet box with power generation terminals configured for electrical attachment to a power generation device. An interior receptacle box, with a plurality of receptacles, maybe joined to the exterior power inlet box with a conduit. The power generation terminals on the exterior power inlet box may be electrically connected to the plurality of receptacles on the interior receptacle box.

In accordance with yet another aspect of the invention, a through-wall power station outlet kit may include an exterior power inlet box for electrical attachment to a power generation device. On the interior side, a receptacle box with a plurality of receptacles may be connected by a conduit within a wall between the exterior and the interior, thereby joining the exterior power inlet box to the interior receptacle box. An electronic display on the interior receptacle box may be utilized to display an amount of electrical energy transferred between the exterior power inlet box and the interior receptacle box. The exterior power inlet box may be selectively, electrically connected to the plurality of receptacles on the interior receptacle box by one of a parallel and series connection to the power generation device.

These and various other features and advantages of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is a perspective view of an assembled through-wall solar power station outlet kit, according to an embodiment of the invention.

FIG. 2 is a front view of only the receptacle box according to an embodiment of the invention.

FIG. 3 is a front view of only the power inlet box according to an embodiment of the invention.

FIG. 4 is a front view of only the power inlet box with a protective bubble cover attached, according to an embodiment of the invention.

FIG. 5 is a front view of a display panel from the receptacle box according to an embodiment of the invention.

FIG. 6 is a diagram of a representative installation using the through-wall solar power station outlet kit according to an embodiment of the invention.

### DETAILED DESCRIPTION

Power generation devices are commonly used for backup power. Such devices include gasoline generators, propane generators, multi-fuel generators, as well as solar panels. These power generation devices are useful to electrically charge a battery bank commonly referred to as a power station. Power stations store electrical energy for later use and regulate the electrical delivery to proper current and voltage for residential use inside a residence, also referred to as an interior.

The power generation device may be electrically connected to the power station in the interior or the power generation device may be electrically connected to the required load such as an appliance that requires electricity. Using a power station allows a user to deliver electrical power to a location in the interior without the use of long extension cables. The power station may be charged and transported throughout the home.

The through-wall power station outlet kit allows a user to connect the power generation device outside to the power station, or appliance, indoors without passing extension cords through a window or doorway. The through-wall power station kit provides for convenient electrical connection with a conduit passing through the wall. A power inlet box on the exterior is electrically connected to a receptacle box on the interior of the building. The through-wall power station kit is pre-configured to allow for simple connection of multiple exterior power generation devices with multiple interior power stations in either parallel or series connection. An electronic display may also be used on the interior receptacle box which shows the user how much current, voltage, and wattage is being utilized in real time.

The through-wall power station outlet kit may include two 20 amp interior receptacles on a receptacle box, allowing charging of a power station with one outlet, then after a period of time moving the power station to electrically power anything, anywhere in the building, all while using the other outlet on the receptacle box to directly power essential devices and appliances.

The through-wall power station outlet kit simplifies the process of connecting an outdoor, inverter style generator in parallel an indoor power station. Using an extension cord configured for parallel attachment, that is also rated at 35 amps, it is possible to configure a powerful setup that keeps the inverter safely outside while delivering a steady power source indoors. Such a configuration is ideal for creating a 30 or 50-amp outlet indoors or effectively managing off-grid power solutions.

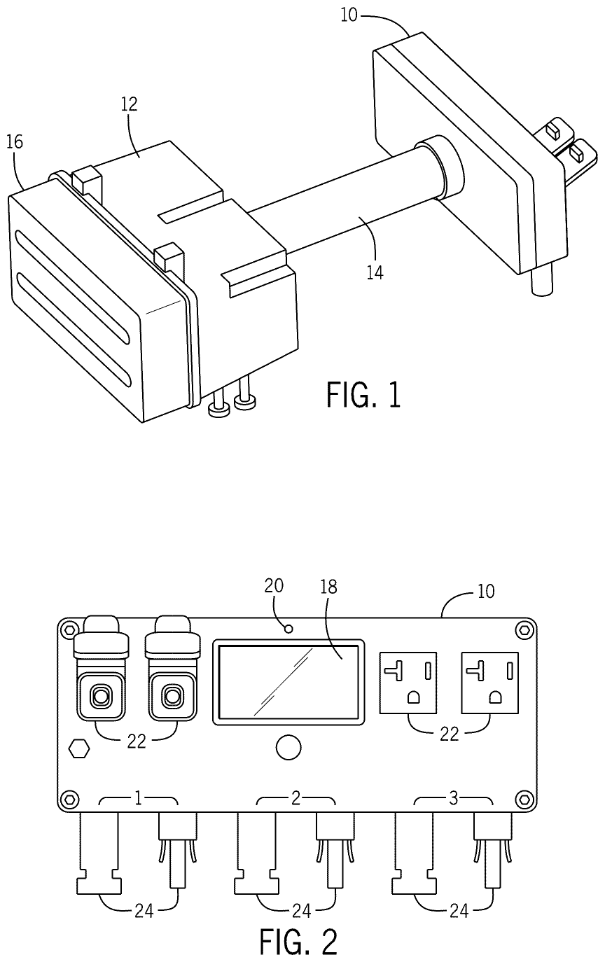

Referring to FIG. 1, a through-wall solar power station outlet kit 8 is shown. A power inlet box 12 is typically installed on an exterior side of a building. A solar power array (not shown) may be electrically wired to the power inlet box 12 to supply electricity. A piece of conduit 14 is used to join a receptacle box 10 to the power inlet box 12, on an interior wall of a building. As a result, the conduit 14 bridges the connection between the power inlet box 12 on the exterior of a building to the receptacle box 10 on the interior of the building. The wiring carrying the electrical energy generated by the solar array passes through the power inlet box 12, through the conduit 14, and to the receptacle box 10. A bubble cover 16 may also be provided to shield the electrical connections within the power inlet box 12 from the elements or other hazards.

The receptacle box 10 is further shown with reference to FIG. 2. A power indicator 20 can be used to show the status, such as powered on, powered off, a malfunction, or the like. More information may be conveyed with a display 18. The display 18 can show information such as the specifications of power being transferred or other pertinent data. Wattage, voltage, amperage, and other information may be shown on the display 18 as well.

A number of interior receptacles 22 provide the opportunity to plug in electrical equipment. Common household appliances that utilize 120 volts may be plugged into the interior receptacles 22. Parallel ports 22 may also be provided for connection of other electrical goods in a parallel connection to a power generation device on the exterior of the building. Any number of quick-connect sockets or terminals may be provided for connection to the receptacle box 10. Additionally, any combination or type of terminals may be used. The power station terminals 24 are only representative of a terminal used to connect a portable power station.

When connecting a portable power station 34, as shown for example in FIG. 3, to the receptacle box 10, the power station terminals 24 may be used. The power station terminals 24 may be of a quick-connect type known as MC4 ports, or they may be any other type of terminal used to connect electrical equipment. The power station terminals 24 provide a quick and convenient way to recharge a portable power station. Such a receptacle box 10 and power inlet box 12 may be used to transfer electrical power from any power generation device on an exterior of a building to the interior. Exemplary power generation devices include gasoline generators, inverter generators, and solar panels.

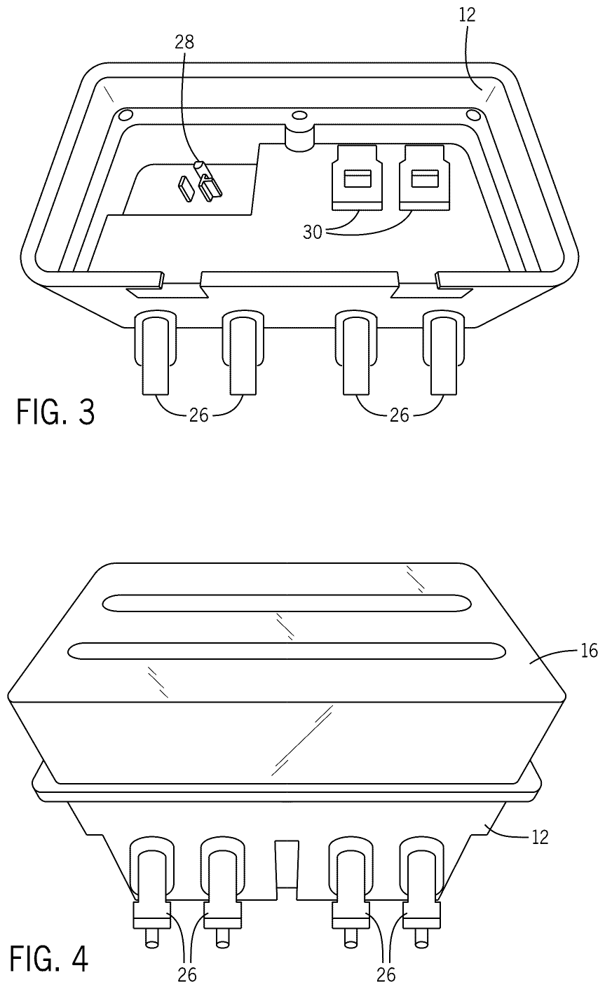

Looking now to FIGS. 3 and 4, the power inlet box 12 is shown with bubble cover 16 in place and without the bubble cover 16, thereby revealing the interior of the power inlet box 12. The bubble cover 16 is utilized as the power inlet box 12 is typically installed in an exterior environment and prevents inclement weather such as rain from contacting the sensitive electrical contacts. The bubble cover 16 may attach with a snap-fit, a fastener, a lock, or the like. It may be totally removable or may include a hinge to rotate open.

A number of power generation terminals 26 are included on the exterior of the power inlet box 12. These are also shown as MC4 terminals, but any other kind of terminal may be used. The power generation terminals 26 are designed to be electrically connected to solar panels 32, shown in FIG. 6, but may also be connected to any other power generation device. The parallel ports 30 are used to connect inverter style generators in parallel to the parallel ports. Solar panels may also be connected to power station terminals 24.

Underneath the bubble cover 16 a male extension cord plug 28 is shown. The male extension cord plug 28 may be used to attach any power generation device such as a generator, an inverter, or solar panels to the power inlet box 12. The male extension cord plug 28 may also be in the form of any known electrical connection that would allow a power generation device to easily be connected to the power inlet box 12. Parallel ports 30 may also be used to attach inverter style generators that are on an exterior of a building, that are pre-configured with quick-connect terminals, to matching plurality of receptacles 22 on an interior side of the building.

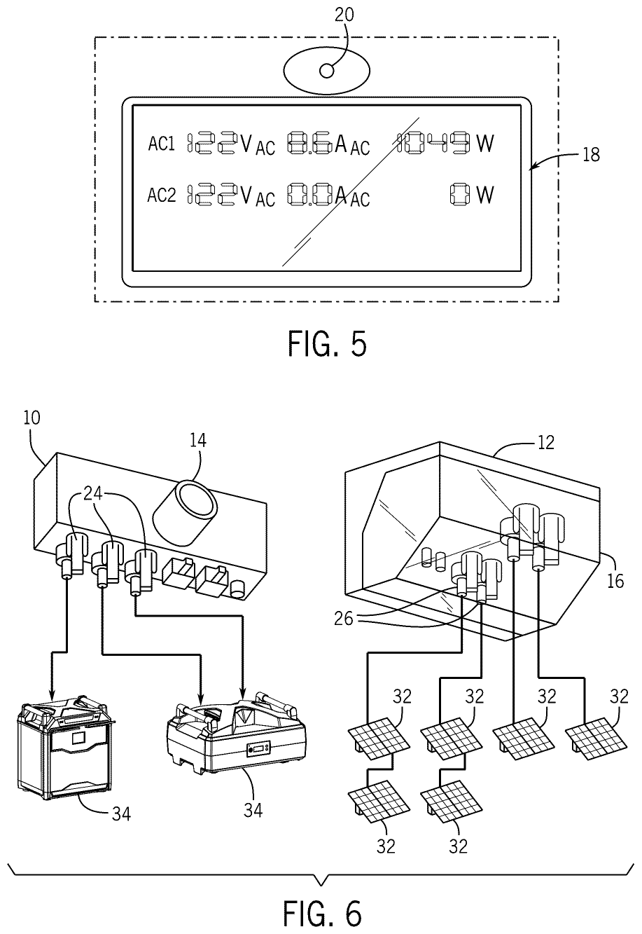

When the through-wall solar power station outlet kit 8 is in use, the display 18 will output data as is shown in FIG. 5. In this example, AC voltage that is being produced, amperage, and wattage is shown. Different rows of data may represent different power station terminals 24 that are in use. For example, one portable power station may be charging at 8.6 amps. A second portable power station may currently be charging at 0 amps, or not charging at all. It is foreseen that the display 18 may be an interactive display as well, allowing the user to toggle setting, view data logs, or read messages indicating function. The power indicator 20 can also be used to flash codes, colors, or the like to communicate information to a user.

With respect to FIG. 6, a typical use case of the through-wall solar power station outlet kit 8 is shown. Solar panels 32 may be connected to the power inlet box 12 in a series or parallel fashion. Individual solar panels 32 may be connected to individual power generation terminals 26 or the solar panels 32 may be wired in groups to the power generation terminals 26. The power inlet box 12 is installed in an exterior location of a building such as on the exterior side of an exterior wall, in proximity to the solar panels 32. The conduit 14, only partially shown, allows the electrical wiring to pass through the exterior wall and into the receptacle box 10 which is mounted to an interior wall. Any number of power stations 34 may be connected to the receptacle box 4. Preferably, the power station terminals 24 are used with quick-connect wire harnesses to deliver electrical energy to the power stations 34.

In accordance with one aspect of the invention, a through-wall power station outlet kit 8 may include a power inlet box 12 located in an exterior environment and protected with a bubble cover 16. The power inlet box 12 may include power generation terminals 26 configured for electrical attachment to a power generation device such as an inverter, a generator, and solar panels 32. On the interior side, a receptacle box 10 may be used with a plurality of power station terminals 26 for electrical connection to a portable power station 34. However, the power station terminals 26 may be used with other terminations such as a solar inverter, a charge controller, or a battery storage build. It is foreseen that any DC electrical system may be used. The preferred use is with solar storage battery systems and inverters. A conduit 14 may join the exterior power inlet box 12 to the interior receptacle box 10 such that the conduit 14 is installed within a wall between the exterior and the interior.

In accordance with another aspect of the invention, the through-wall power station outlet kit 8 may include an exterior power inlet box 12 with power generation terminals 26 configured for electrical attachment to a power generation device 32. An interior receptacle box 10, with a plurality of receptacles 22, maybe joined to the exterior power inlet box 12 with a conduit 14. The power generation terminals 26 on the exterior power inlet box 12 may be electrically connected to the plurality of receptacles 22 on the interior receptacle box 10.

In accordance with yet another aspect of the invention, a through-wall power station outlet kit 8 may include an exterior power inlet box 12 for electrical attachment to a power generation device 32. On the interior side, a receptacle box 10 with a plurality of receptacles 22 may be connected by a conduit 14 within a wall between the exterior and the interior, thereby joining the exterior power inlet box 12 to the interior receptacle box 10. An electronic display 18 on the interior receptacle box 10 may be utilized to display an amount of electrical energy transferred between the exterior power inlet box 12 and the interior receptacle box 10. The exterior power inlet box 12 may be selectively, electrically connected to the plurality of receptacles 22 on the interior receptacle box 10 by one of a parallel and series connection to the power generation device 32.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims. In the appended claims, the singular forms of “a,” “an,” and “the” include their corresponding plural references unless the context clearly dictates otherwise.

What is claimed is:

1. A through-wall power station outlet kit comprising:
a power inlet box configured for use in an exterior with a bubble cover, the power inlet box including power generation terminals configured for electrical attachment to a power generation device;
a receptacle box configured for use in an interior, the receptacle box including a plurality of power station terminals for electrical connection to a portable power station; and
a conduit joining the exterior power inlet box to the interior receptacle box, wherein the conduit is installed within a wall between the exterior and the interior.

2. The through-wall power station outlet kit according to claim 1, wherein the exterior power inlet box includes an electrical connection configured for attachment to an extension cord for connection to a power generation device including one of an exterior generator, an inverter, and a solar panel.

3. The through-wall power station outlet kit according to claim 2, wherein the electrical connection configured for attachment to an extension cord is a male, three prong electrical plug.

4. The through-wall power station outlet kit according to claim 2, wherein the interior receptacle box includes an electrical connection configured for attachment to an interior portable power station, thereby electrically joining the exterior one of generator, inverter, and solar panel with the interior portable power station.

5. The through-wall power station outlet kit according to claim 2, wherein the exterior power inlet box further includes electrical parallel ports and wherein the electrical parallel ports are configured for attachment to the power generation device.

6. The through-wall power station outlet kit according to claim 5, wherein the power generation device is an inverter.

7. The through-wall power station outlet kit according to claim 5, wherein the electrical parallel ports on the exterior power inlet box are electrically connected to a set of parallel interior receptacles on the interior receptacle box, and wherein the set of parallel interior receptacles are configured for parallel attachment with the power station.

8. A through-wall power station outlet kit comprising:
an exterior power inlet box with power generation terminals configured for electrical attachment to a power generation device;
an interior receptacle box with a plurality of receptacles;
a conduit within a wall between the exterior and the interior joining the exterior power inlet box to the interior receptacle box; and
wherein the power generation terminals on the exterior power inlet box are electrically connected to the plurality of receptacles on the interior receptacle box.

9. The through-wall power station outlet kit according to claim 8, further comprising an electronic display configured for displaying the amount of electrical energy being transferred between the exterior power inlet box and the interior receptacle box.

10. The through-wall power station outlet kit according to claim 8, further comprising:
a pair of solar panels configured to receive solar energy electrically connected to a set of power generation terminals on the exterior power inlet box;
a power station electrically connected to a set of power station terminals on the interior receptacle box; and
wherein the solar panels transfer electrical energy through the exterior power inlet box, through the conduit, and through the interior power inlet box and into a power station to electrically recharge the power station.

11. The through-wall power station outlet kit according to claim 10, wherein the solar panels are electrically connected in a parallel connection to the power inlet box thereby doubling a current produced.

12. The through-wall power station outlet kit according to claim 11, wherein the parallel connection is maintained through the exterior power inlet box and through the interior receptacle box without the use of an additional device.

13. A through-wall power station outlet kit comprising:
an exterior power inlet box configured for electrical attachment to a power generation device;
an interior receptacle box with a plurality of receptacles;
a conduit within a wall between the exterior and the interior joining the exterior power inlet box to the interior receptacle box;
an electronic display on the interior receptacle box configured for displaying an amount of electrical energy transferred between the exterior power inlet box and the interior receptacle box; and
wherein the exterior power inlet box is selectively electrically connected to the plurality of receptacles on the interior receptacle box by one of a parallel and series connection to the power generation device.

14. The through-wall power station outlet kit according to claim 13, wherein the power generation device is at least a pair of solar panels connected to the exterior power inlet box in series connection.

15. The through-wall power station outlet kit according to claim 14, further comprising a power station electrically connected to the interior receptacle box in series with the solar panels.

16. The through-wall power station outlet kit according to claim 14, wherein the interior receptacle box includes a plurality of power station terminals configured for electrical attachment to a plurality of power stations simultaneously.

17. The through-wall power station outlet kit according to claim 13, further comprising a plurality of power station terminals configured for electrical connection to multiple power stations for simultaneous charging of the power stations and electrical use of the plurality of receptacles.

18. The through-wall power station outlet kit according to claim 14, wherein the plurality of solar panels is user configurable to either one of parallel and series electrical connection with the exterior power inlet box.

19. The through-wall power station outlet kit according to claim 18, wherein the either one of parallel and series electrical connection of the solar panels is maintained through the conduit and through the interior receptacle box.

20. The through-wall power station outlet kit according to claim 14, wherein the display indicates amperage, voltage, and wattage being transferred through the interior receptacle box.
